(19) United States
(12) Patent Application Publication
(10) Pub. No.: US 2026/0177046 A1
(43) Pub. Date: Jun. 25, 2026

(54) ELECTRIC COMPRESSOR

(71) Applicant: Hanon Systems, Daejeon (KR)

(72) Inventors: Hyun Woo Lee, Daejeon (KR); Min Gyu Kim, Daejeon (KR); Seung Kil Kim, Daejeon (KR); Sang Woo Bae, Daejeon (KR); Hew Nam Ahn, Daejeon (KR); Sung Taeg Oh, Daejeon (KR); Young Seop Yoon, Daejeon (KR); Je Su Yun, Daejeon (KR); Sung Myung Lee, Daejeon (KR)

(21) Appl. No.: 18/861,945

(22) PCT Filed: Nov. 6, 2023
(86) PCT No.: PCT/KR2023/017607

§ 371 Date: Oct. 31, 2024

(30) Foreign Application Priority Data
Feb. 21, 2023 (KR) 10-2023-0022983

(51) Int. Cl. F04B 39/06; F04B 35/04; F04B 39/12; H02K 11/33

(52) U.S. Cl. CPC F04B 39/06; F04B 35/04; F04B 39/121; H02K 11/33

(57) ABSTRACT

An electric compressor, including: a housing; a compressing part provided in the housing: a motor part provided in the housing and configured to drive the compressing part; and an inverter part coupled to one side of the housing and configured to control the motor part, the inverter part may include: an inverter body disposed on one side of the housing: a circuit board seated in the inverter body; an inverter cover disposed on one side of the inverter body and covering the circuit board; and at least one or more fastening members penetrating the inverter cover and the circuit board to be fastened to the housing.

### CROSS REFERENCE TO RELATED PATENT APPLICATIONS

This is a U.S. national phase patent application of PCT/KR2023/017607 filed Nov. 6, 2023, which claims the benefit of and priority to Korean Patent Application No. 10-2023-0022983, filed on Feb. 21, 2023, the entire contents of each of which are incorporated herein by reference for all purposes.

### TECHNICAL FIELD

The present disclosure relates to an electric compressor, more specifically, to an electric compressor capable of improving a resonance noise of an inverter cover thanks to weight reduction and increase of natural frequencies and having an improved grounding power and cooling performance of a switching element, by fastening an inverter cover and a circuit board altogether to a motor housing using a single fastening member and pressurizing the circuit board toward a motor housing by a limiter soldered to the circuit board.

### BACKGROUND ART

Generally, air conditioning (A/C) apparatuses for cooling or heating passenger compartments are installed in vehicles. Such an air conditioning apparatus includes a compressor, which compresses low-temperature and low-pressure gaseous refrigerant drawn from an evaporator into a high-temperature and high-pressure gaseous state, and transfers it to a condenser.

Compressors applied to such vehicles include a mechanical compressor that is driven by receiving the driving force of the engine and an electric compressor that uses a motor driven by electricity, and in recent years, the use of electric compressors has increased as the vehicle electrification has been accelerated.

Meanwhile, examples of the compressor include a reciprocating compressor that compresses a refrigerant according to which pistons reciprocate, and a rotary compressor that compresses a refrigerant while rotating. The reciprocating compressor includes a crank compressor that transmits a driving force from a drive source to a plurality of pistons using a crank, a swash plate compressor that transmits a driving force from a drive source to a shaft installed with a swash plate, and the like, according to the power transmission from the drive source. The rotary compressor includes a vane rotary compressor that utilizes a rotating rotary shaft and vane, and a scroll compressor that utilizes an orbiting scroll and a fixed scroll.

In addition, research and development of an inverter-type compressor capable of varying an operating speed of a motor has been actively conducted in a field of the electric compressor. An example of the conventional inverter-type electric compressor is disclosed in Korea Patent No. 2022-0131164.

According to one example of the conventional electric compressor, an electric compressor 10 includes a housing 11, a compression portion 12, an electric motor 13, and an inverter portion 14. The housing 11 is made of an aluminum alloy, and has a motor housing 15 accommodating the compression portion 12 and the electric motor 13, and an inverter housing accommodating the inverter portion 14. A three-phase terminal portion 26 configured to supply a three-phase alternating current power from the inverter portion 14 to the electric motor 13 penetrates the inverter housing 18 and the motor housing 15, and is electrically connected to the circuit board 33.

At this instance, a screw hole 25 into which a bolt (not illustrated) for fastening the inverter cover 24 is inserted is formed on an outer wall portion 23 of the inverter housing 18. In addition, a screw hole 28 into which a bolt 50 for fastening the circuit board 33 is formed in a seating portion 27 of the inverter housing 18.

As such, in the prior art patent, there was a problem in that a large quantity of bolts are required because the bolt for fastening the inverter cover 24 and the inverter housing 18 to each other, and the bolt 50 for fastening the circuit board 33 and the inverter housing 18 to each other and grounding them are configured separately, and therefore, the weight increased.

In addition, the inverter cover 24 is formed to be long, while the fastening bolt is disposed only on an outer area and cannot be disposed at the center, thereby the natural frequencies were low and a noise caused by the resonance of the inverter cover was generated.

### SUMMARY

An object of the present disclosure is to provide an electric compressor capable of improving a resonance noise of an inverter cover thanks to weight reduction and increase of natural frequencies and having an improved grounding power and cooling performance of a switching element, by fastening an inverter cover and a circuit board altogether to a motor housing using a single fastening member and pressurizing the circuit board toward a motor housing by a limiter soldered to the circuit board.

The technical problem to be achieved by the present disclosure is not limited to the above-mentioned technical problem, and other technical problems that are not mentioned will be clearly understood by ordinary-skilled persons in the art to which the present disclosure pertains from the following description.

One embodiment is an electric compressor, including: a housing; a compressing part provided in the housing: a motor part provided in the housing and configured to drive the compressing part; and an inverter part coupled to one side of the housing and configured to control the motor part, the inverter part may include: an inverter body disposed on one side of the housing: a circuit board seated in the inverter body; an inverter cover disposed on one side of the inverter body and covering the circuit board; and at least one or more fastening members penetrating the inverter cover and the circuit board to be fastened to the housing.

According to an embodiment, the fastening members may penetrate the inverter cover, the circuit board, and the inverter body to be fastened to the housing.

According to an embodiment, the electric compressor may further include: at least one or more limiters in contact with the circuit board and allowing the fastening members to penetrate an inside thereof.

According to an embodiment, when the fastening member may be fastened to the housing, the limiter may be in contact with the inverter cover.

According to an embodiment, the limiter may pressurize the circuit board toward the housing by a fastening force of the fastening member.

According to an embodiment, the limiter may be soldered and surface mounted to a surface of the circuit board facing the inverter cover.

According to an embodiment, the limiter may penetrate the circuit board and may be soldered to a surface facing the housing through a flange.

According to an embodiment, the fastening member may be provided in plural number, and at least one among the plurality of fastening members may be disposed to be closer to a center line than to a tip end with respect to a longitudinal direction in which a length of the inverter cover is a longest.

According to an embodiment, the fastening member may be provided in plural number, and the plurality of fastening members may be disposed more on a side on which a switching element connected to the circuit board is disposed based on a longitudinal center line which is perpendicular to a longitudinal direction in which a length of the inverter cover is a longest, and is passing a center of the inverter cover.

According to an embodiment, the plurality of fastening members disposed on the side on which the switching element is disposed based on the longitudinal center line of the inverter cover may be disposed in one line.

According to an embodiment, the inverter cover may include a plurality of guide protrusions, and a plurality of guide holes into which the plurality of guide protrusions are inserted may be formed on the circuit board.

According to an embodiment, a stepped surface protruding toward the circuit board may be formed around each of the plurality of guide protrusions.

According to an embodiment, at least some of the plurality of guide protrusions may be heat-fused.

According to an embodiment, the guide hole may have a diameter which is smaller than a diameter of a fastening hole formed on the circuit board to allow the fastening member to penetrate.

According to an embodiment, the inverter body may be made of a plastic material.

According to the present disclosure, it is possible to reduce weight because a quantity of bolts can be reduced by fastening the inverter cover and the circuit board altogether to the motor housing using a single fastening member and to improve the resonance noise of the inverter cover by increasing of natural frequencies because a distance between the fastening members is reduced.

In addition, a limiter soldered to the circuit board may serve as a ground in terms of a function, while electrically connecting the inverter cover, the circuit board, and the motor housing, thereby the grounding power is improved.

In addition, a cooling performance of the switching element may be improved because the limiter may pressurize the circuit board, in particular, the switching element, toward the motor housing by a fastening force of the fastening member.

Further, it is possible to align the inverter body and the circuit board before fastening them using the fastening member because the inverter body and the circuit board include a guide protrusion and a guide hole configured to be engaged with each other, respectively, and to seat the circuit board on the inverter body more stably through heat-fusion.

The effects of the embodiments of the present disclosure are not limited to the above-mentioned effects, and it should be understood that the effects of the present disclosure include all effects that could be inferred from the configuration of the invention described in the detailed description of the invention or the appended claims.

### DESCRIPTION OF DRAWINGS

FIG. 1 is an exploded perspective view of an electric compressor according to an embodiment of the present disclosure,

FIG. 2 is a cross-sectional view partially illustrating a state in which an electric compressor of FIG. 1 is coupled.

FIG. 3 is a front view illustrating a state in which an electric compressor of FIG. 1 is coupled, and an inverter cover is separated.

FIG. 4 is a front view in a state in which a circuit board of FIG. 1 is separated.

FIG. 5 is a front view in a state in which an inverter body of FIG. 1 is separated.

FIG. 6 is a rear view of FIG. 5 illustrating a state in which a circuit board is mounted.

FIG. 7 is a perspective view illustrating a state in which a limiter is surface mounted to a circuit board.

FIG. 8 is a cross-sectional view illustrating a state in which a limiter penetrates a circuit board and is soldered.

FIGS. 9A and 9B are perspective views illustrating A part and B part of FIG. 5, respectively.

FIGS. 10A and 10B are cross-sectional views taken along X-X line of FIG. 3, illustrating states before and after heat-fusion of a guide protrusion.

### DESCRIPTION OF AN EMBODIMENT

Hereinafter, exemplary embodiments of the electric compressor of the present disclosure will be described with reference to the accompanying drawings.

In addition, terms used herein are defined in consideration of functions in the present disclosure, and may vary according to user's or operator's intention or practices, and the following embodiments do not limit the scope of the present disclosure, but are merely examples of the components presented in the claims.

In addition, parts irrelevant to the description are omitted for clarity of description, and same or similar components are assigned with the same reference numerals throughout the specification. It will also be understood that the terms “comprises” and “includes” used herein specify the presence of stated elements, but do not preclude the presence or addition of other elements, unless otherwise defined.

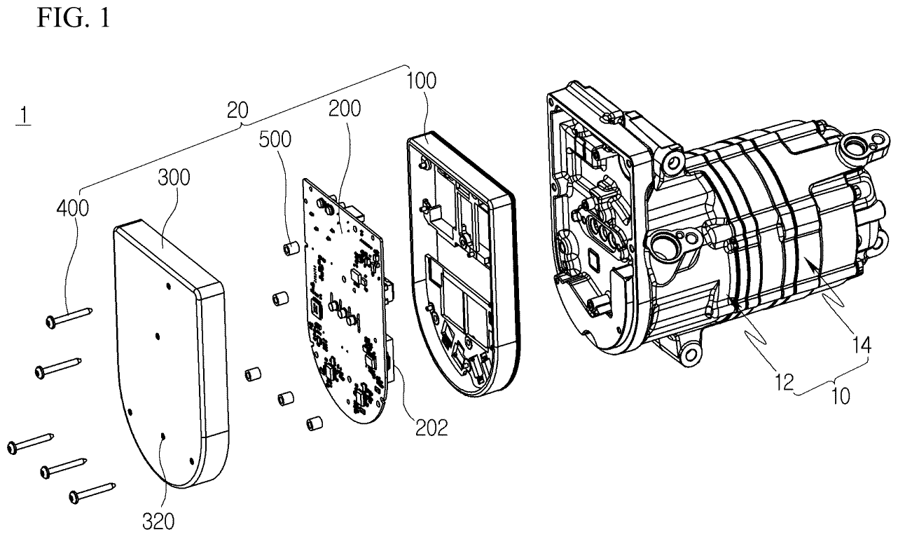

First, the configuration of the electric compressor 1 according to an embodiment of the present disclosure will be briefly described with reference to FIG. 1.

The electric compressor of the present disclosure includes a housing 10, a motor part, a compressing part, and an inverter part 20.

The housing 10 forms an exterior of the electric compressor 1, and in this embodiment, the housing 10 consists of a front housing (a motor housing) 12 and a rear housing 14.

The motor part is provided in the front housing 12, and provides power to the compressing part for compressing a refrigerant. Although not illustrated, the motor part may include a rotor coupled to a rotary shaft rotatably installed at a center of the front housing 12 and a stator fixed to the front housing 12 and disposed radially outside the rotor. Also, the stator may include a stator core and coils wound around the stator core.

The compressing part is provided in the rear housing 14 and although not illustrated, may include an orbiting scroll coupled to the rotary shaft through an eccentric bush, and a fixed scroll forming a compression chamber in which the refrigerant is compressed together with the orbiting scroll. As such, since the compressing part is connected to the motor part through the rotary shaft, the rotational force generated by the motor part may be transferred to the orbiting scroll of the compressing part through the rotary shaft. However, it is not limited thereto, and it is apparent that other types of compressing parts may be used.

The inverter part 20 is coupled to one side of the housing 10 which is an opposite side of the compressing part with respect to the motor part. The inverter part 20 is electrically connected to the motor part, supplies power to the motor part and controls operation of the motor part by means of power and control signals transmitted from an outside. Specifically, the stator forms an electromagnetic field by power applied from the inverter part 20, and rotational force for driving the compressing part is generated as the rotor rotates by the electromagnetic field formed by the stator.

At this time, the motor part, and the inverter part 20 may be electrically connected to each other by a connection pin. Since a three-phase motor is used in this embodiment, three connection pins connected to the three phases, respectively, are provided in order to supply three-phase power from the inverter part 20 to the motor part. The three connection pins are electrically connected to the three-phase coils of the stator, respectively, pass through the front housing 12 and protrude toward an inside of the inverter part 20. Each of the connection pins protruding to the inside of the inverter part 20 penetrates a circuit board 200 of the inverter part and is electrically connected to the circuit board 200. To this end, through holes may be formed on one side of the front housing 12 and on the circuit board 200 so as to allow the connection pin to pass therethrough.

Hereinafter, the inverter part 20 will be described in detail with reference to FIGS. 1 to 7. The inverter part 20 may include an inverter body 100, the circuit board 200, an inverter cover 300, a fastening member, and a limiter 500.

The inverter body 100 is disposed on one side of the front housing 12, and the circuit board 200 to which the switching elements are connected is seated on the inverter body 100. The inverter body 100 is made of plastic resin in order to reduce costs and make the inverter body 100 lighter. Depending on embodiments, an electromagnetic interference shielding member (not illustrated) made of a metal may be provided on an inside or an outside of the inverter body 100 in order to allow shielding from an electromagnetic wave's interference even if the inverter body 100 is made of plastic resin.

The inverter cover 300 is disposed on one side of the inverter body 100 and covers the circuit board 200. In the present embodiment, the inverter cover 300 is formed to be identical to a shape of the inverter body 100 and covers one side of the inverter body 100 entirely.

At this instance, at least one or more fastening members penetrate the inverter cover 300, the circuit board 200, and the inverter body 100, and are fastened to the front housing 12. In the present embodiment, the description will be provided on the basis that the fastening members are fastening bolts 400. That is, the inverter cover 300 and the circuit board 200 together are coupled to the front housing 12 through single kind of fastening bolt 400, rather than falling within a case in which the inverter cover 300 and the circuit board 200 are coupled to the front housing 12, respectively, through different kinds of fastening bolts. To this end, first to third fastening holes 120, 220, and 320 that the fastening bolt 400 penetrates are illustrated on the inverter body 100, the circuit board 200, and the inverter cover 300, respectively. As such, it is possible to reduce weight because a quantity of bolts can be reduced by fastening the inverter cover 300 and the circuit board 200 together to the front housing 12 using the single kind of fastening bolt 400. In the present embodiment, a plurality of fastening members are provided, and five fastening bolts 400a to 400e are illustrated as an example, however, the present embodiment is not limited thereto.

It is desirable that at least one among the plurality of fastening bolts 400 is disposed to be closer to a center line CL than to a tip end with respect to a longitudinal direction in which a length of the inverter cover 300 is the longest. As illustrated in FIG. 3, in the present embodiment, one fastening bolt 400b is disposed to be closer to the center line CL in the longitudinal direction of the inverter cover 300. Accordingly, it is possible to support a center portion of the inverter cover 300, and as a result, a distance between fastening bolts 400 is reduced compared to the conventional structure in which the fastening bolts for fastening the inverter cover are disposed only on outer side of the inverter cover 300, thereby the resonance noise of the inverter cover 300 can be improved by increasing the natural frequencies.

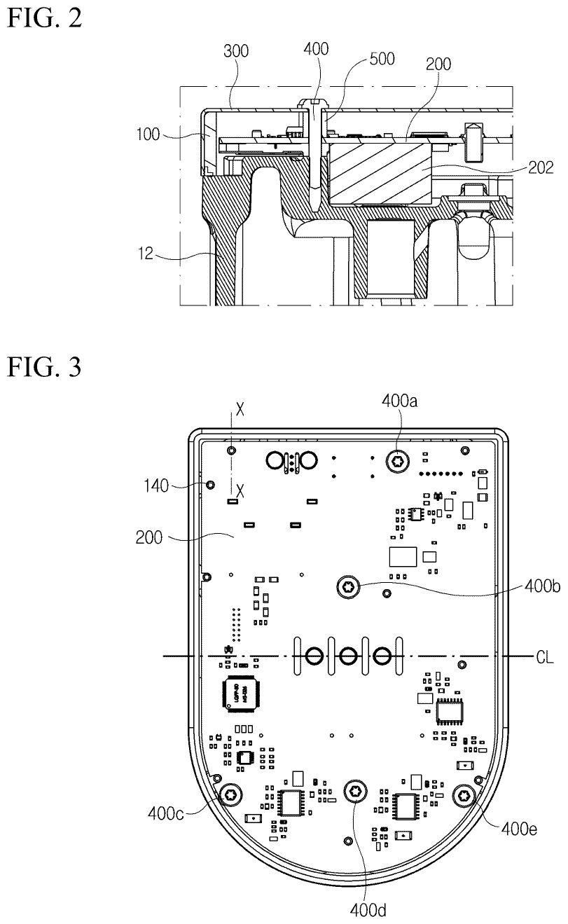

A plurality of limiters 500 contact the circuit board 200, and the plurality of fastening bolts 400 penetrate each inside of the plurality of limiters 500. In the present embodiment, a plurality of limiters 500 are provided in correspondence with the plurality of fastening bolts 400. The limiter 500 is provided between the inverter cover 300 and the circuit board 200, and as illustrated in FIG. 2, when the fastening bolt 400 is fastened to the front housing 12, the limiter 500 is in contact with the inverter cover 300. The limiter 500 is formed to have a cylindrical shape having a hollow hole and the fastening bolt 400 penetrates an inside of the limiter 500, therefore, the limiter 500 may serve as a guide for the fastening bolt 400. The limiter 500 may be formed of a metal material.

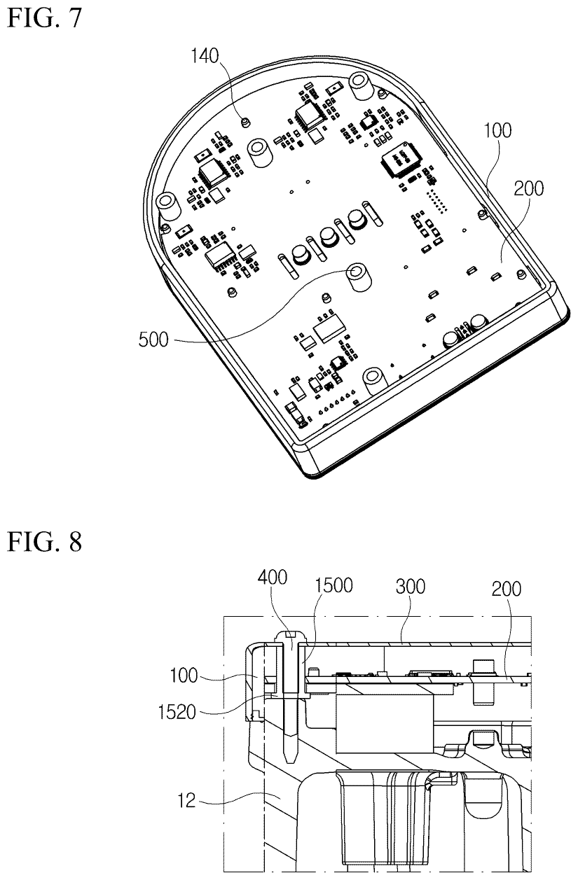

As illustrated in FIG. 7, in the present embodiment, the limiter 500 is soldered and surface mounted to a surface of the circuit board 200 facing the inverter cover 300. Accordingly, when the fastening bolt 400 is fastened, the inverter cover 300 contacts the limiter 500, and generates a force pressurizing the limiter 500 to the housing 10 side. As a result, the limiter 500 may pressurize the circuit board 200 toward the housing side 10 by a fastening force of the fastening bolt 400.

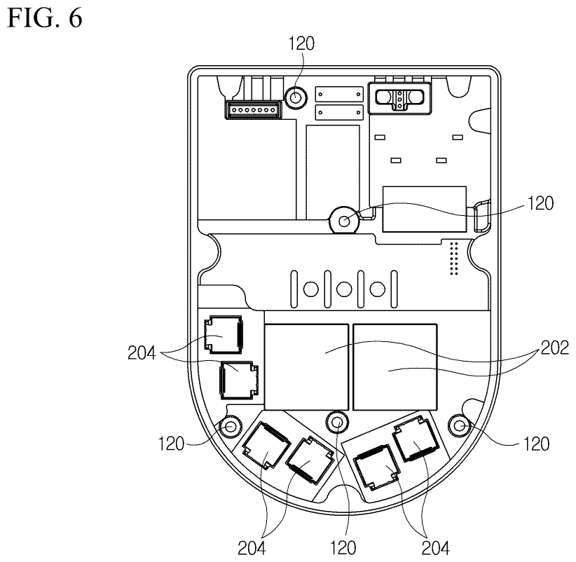

In particular, it is desirable that the fastening bolts 400 are disposed more on a side on which a switching element 204 connected to the circuit board 200 is disposed based on a longitudinal center line CL which is perpendicular to a longitudinal direction in which a length of the inverter cover 300 is the longest, and passing through a center of the inverter cover 300. As illustrated in FIG. 6, in the present embodiment, based on the longitudinal center line CL of the inverter cover 300, a capacitor 202 and the switching elements 204 are disposed on a lower side, and therefore, it is seen that a greater number of fastening bolts 400 are disposed on the lower side than an upper side based on the longitudinal center line CL of the inverter cover 300. In more detail, as illustrated in FIG. 3, based on the longitudinal center line CL of the inverter cover 300, two fastening bolts 400a and 400b are disposed on the upper side, and three fastening bolts 400c, 400d, and 400e are disposed on the lower side.

At this time, three fastening bolts 400c, 400d, and 400e, which are disposed on a side on which the switching element 204 is disposed based on the longitudinal center line CL of the inverter cover 300, may be disposed in one line. With this configuration, all surfaces of the switching elements 204 can come in close contact with the front housing 12, thereby cooling of the switching element can be performed effectively.

As described above, the limiter 500 soldered to the circuit board 200 electrically connects the inverter cover 300, the circuit board 200, and the front housing 12 to each other, and may serve as the ground in its function, thereby the grounding power can be improved. In addition, because the limiter 500 may pressurize the circuit board 200, in particular, the switching element 204 toward the housing 10 side by a fastening force of the fastening bolt 400, the cooling performance of the switching element can be improved.

However, the embodiment is not limited thereto, and as illustrated in FIG. 8, a limiter 1500 may penetrate the circuit board 200 and may be soldered to a surface facing the housing 10 through a flange 1520. In this case, because the fastening bolt 400 and the limiter 1500 must penetrate the circuit board 200 together, the second fastening hole 220 of the circuit board may become greater than a size of the second fastening hole 220 used in a case in which the limiter is surface mounted.

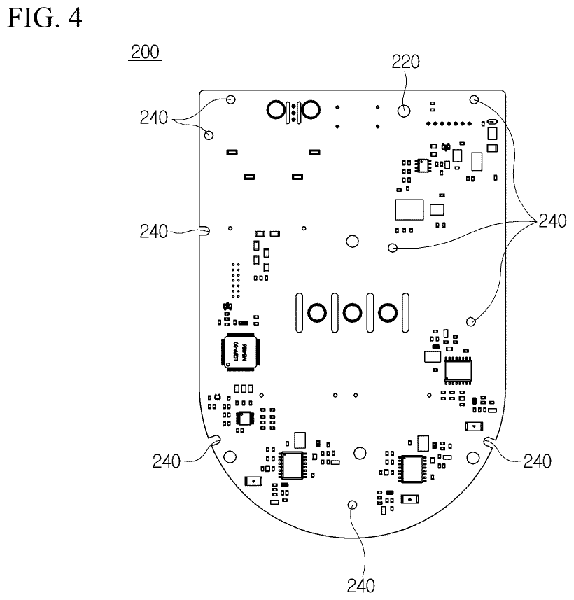

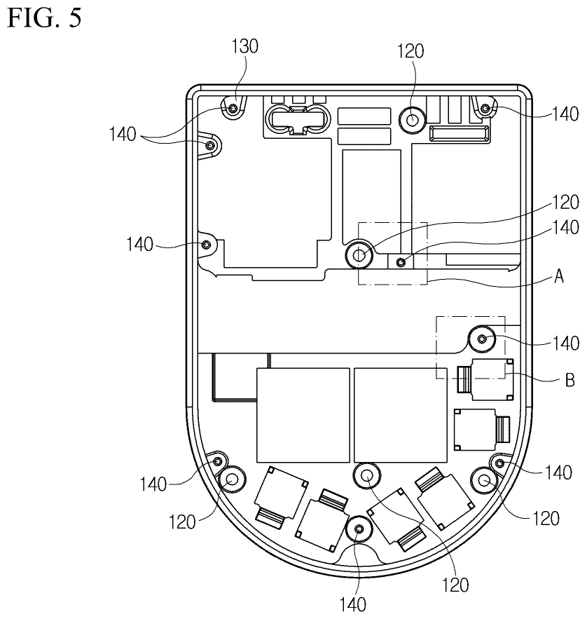

According to the embodiment, as illustrated in FIGS. 4 and 5, the inverter body 100 may include a plurality of guide protrusions 140, and a plurality of guide holes 240, into which the plurality of guide protrusions 140 are inserted, respectively, may be formed on the circuit board 200. In the present embodiment, nine guide protrusions 140 and nine guide holes 240 are formed, but the embodiment is not limited thereto. As the inverter body 100 and the circuit board 200 include the guide protrusions 140 and the guide holes 240 configured to be engaged with each other, the inverter body 100 and the circuit board 200 may be aligned with each other before fastening with the fastening member.

In order to secure a space on the circuit board 200 for disposing elements, it is desirable that the guide hole 240 has a smaller diameter than a diameter of the second fastening hole 220 that the fastening bolt 400 penetrates. The plurality of guide holes 240 are disposed closer to the second fastening hole 220, or on an outer area of the circuit board 200. The guide holes 240 may be formed to be a through hole penetrating the circuit board, or a cutout hole cut toward an inside from an outer periphery of the circuit board.

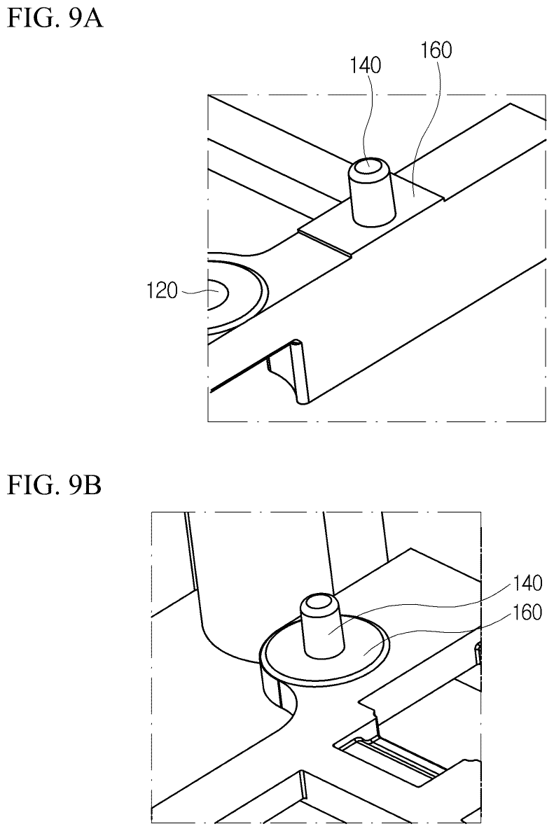

Around each of the guide protrusions 140, a stepped surface 160 protruding toward the circuit board 200 may be formed. In FIGS. 9A and 9B, a rectangular or a circular stepped surface 160 surrounding the guide protrusion 140 is illustrated. With this configuration, it is possible to prevent the circuit board 200 from being lifted due to interference with the inverter body 100, and to assist the circuit board 200 in stably seating on the inverter body 100.

At least some of the plurality of guide protrusions 140 may be formed on the flange 130 protruding inward from a periphery of the inverter body 100. The flange 130 forms a surface having the same height as a height of the stepped surface 160, therefore, the flange 130 may support the circuit board 200 on a plane.

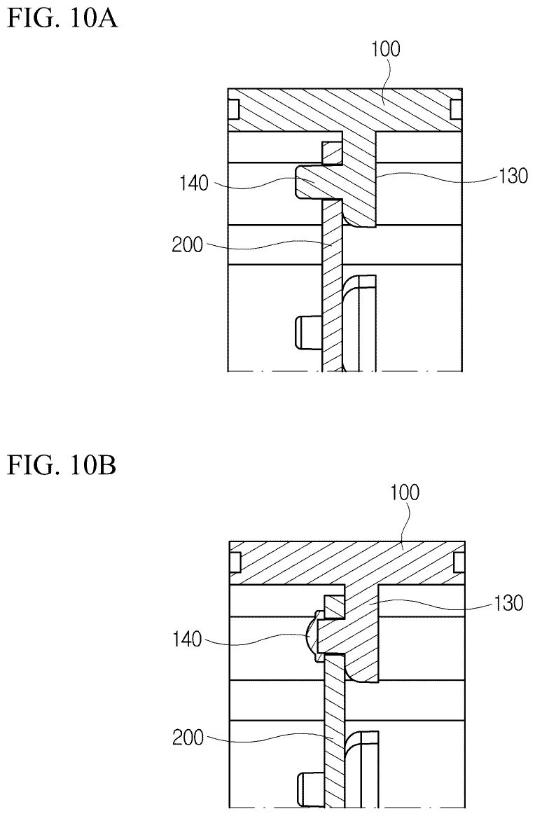

At this time, at least one of the plurality of guide protrusions 140 may be heat-fused. The inverter body 100 is made of a plastic material, therefore, the heat-fusion can be performed. FIGS. 10A and 10B illustrate states before and after the heat-fusion of the guide protrusion 140. As such, because the guide protrusion 140 is heat-fused and fixed on the guide hole 240, it is possible to more stably seat the circuit board 200 on the inverter body 100.

The present disclosure is not limited to the above-described specific embodiments and descriptions, and various modifications may be made by those skilled in the art without departing from the gist of the present disclosure claimed in the claims. Such variations are within the protection scope of the present disclosure.

The present disclosure relates to an electric compressor, more specifically, to an electric compressor capable of improving a resonance noise of an inverter cover thanks to weight reduction and increase of natural frequencies and having an improved grounding power and cooling performance of a switching element, by fastening an inverter cover and a circuit board altogether to a motor housing using a single fastening member and pressurizing the circuit board toward a motor housing by a limiter soldered to the circuit board.

1-15. (canceled)

16. An electric compressor, comprising:
a housing;
a compressing part provided in the housing:
a motor part provided in the housing and configured to drive the compressing part; and
an inverter part coupled to one side of the housing and configured to control the motor part,
wherein the inverter part further comprises:
an inverter body disposed on one side of the housing:
a circuit board seated in the inverter body;
an inverter cover disposed on one side of the inverter body and covering the circuit board; and
at least one or more fastening members penetrating the inverter cover and the circuit board to be fastened to the housing.

17. The electric compressor of claim 16, wherein the at least one or more fastening members penetrate the inverter cover, the circuit board, and the inverter body to be fastened to the housing.

18. The electric compressor of claim 16, further comprising at least one or more limiters in contact with the circuit board and allowing the at least one or more fastening members to penetrate an inside thereof.

19. The electric compressor of claim 18, wherein when the at least one or more fastening members are fastened to the housing, and the at least one or more limiters are in contact with the inverter cover.

20. The electric compressor of claim 19, wherein the at least one or more limiters pressurize the circuit board toward the housing by a fastening force of the at least one or more fastening members.

21. The electric compressor of claim 19, wherein the at least one or more limiters are soldered and surface mounted to a surface of the circuit board facing the inverter cover.

22. The electric compressor of claim 19, wherein the at least one or more limiters penetrate the circuit board and are soldered to a surface facing the housing through a flange.

23. The electric compressor of claim 16, wherein the at least one or more fastening members are provided as a plurality, and at least one of the plurality of fastening members is disposed to be closer to a center line than to a tip end with respect to a longitudinal direction in which a length of the inverter cover is a longest.

24. The electric compressor of claim 20, wherein the at least one or more fastening members are provided as a plurality, and the plurality of fastening members are disposed more on a side on which a switching element connected to the circuit board is disposed based on a longitudinal center line which is perpendicular to a longitudinal direction in which a length of the inverter cover is a longest, and is passing a center of the inverter cover.

25. The electric compressor of claim 24, wherein the plurality of fastening members disposed on the side on which the switching element is disposed based on the longitudinal center line of the inverter cover are disposed in one line.

26. The electric compressor of claim 16, wherein the inverter cover further comprises a plurality of guide protrusions, and wherein a plurality of guide holes into which the plurality of guide protrusions are inserted are formed on the circuit board.

27. The electric compressor of claim 26, wherein a stepped surface protruding toward the circuit board is formed around each of the plurality of guide protrusions.

28. The electric compressor of claim 26, wherein at least some of the plurality of guide protrusions are heat-fused.

29. The electric compressor of claim 26, wherein the plurality of guide holes have a diameter which is smaller than a diameter of a fastening hole formed on the circuit board to allow the at least one or more fastening members to penetrate.

30. The electric compressor of claim 16, wherein the inverter body is made of a plastic material.
